(19) United States
(12) Patent Application Publication
(10) Pub. No.: US 2020/0055076 A1
(43) Pub. Date: Feb. 20, 2020

(54) METHOD AND DEVICE FOR PRODUCING A PRIMARY BACKING ON A WEB MATERIAL

(71) Applicant: KIENER MASCHINENBAU GMBH, LAUCHHEIM (DE)

(72) Inventors: Jurgen kiener, LAUCHHEIM (DE); STEFAN KIENER, LAUCHHEIM (DE)

(21) Appl. No.: 16/343,767

(22) PCT Filed: Oct. 24, 2017
(86) PCT No.: PCT/EP2017/077104

§ 371 Date: Apr. 21, 2019

(30) Foreign Application Priority Data
Oct. 24, 2016 (DE) 10 2016 120 169.3

(51) Int. Cl. B05C 1/08; B29C 59/04

(52) U.S. Cl. CPC B05C 1/08; B32B 37/1036; B29C 59/04

(57) ABSTRACT

The invention relates to a method for producing a primary backing (19) on a web material (11), in which the web material (11) is fed to an application device (33) with a guide roller (31) and is subsequently discharged from the application device (33) with a guide roller (34) that is mounted downstream thereof, wherein the web material (11) is guided along the application device (33) with a web guide device (36), and the web material (11) is held in a wrap-around angle (α) with respect to the application device (33) with a transport belt (44) of the web guide device (36) and is guided in a contacting manner within a wrap-around angle (α) along the application device (33).

The invention relates to a method and a device for producing a primary backing on a web material.

DE 835 807 B proposes a machine for producing webs of rubber, plastics materials or the like. Said machine comprises a revolving conveyor belt which is guided along a heatable drum, wherein said heatable drum assigned deflection pulleys. In a processing station, a still shapeless mass is applied as a raw material which is subsequently processed into a layer. The conveyor belt and the still unconsolidated mass is fed to the heatable drum via an input roll. The web material that is formed is wound by a following deflection pulley. A fixed wrap angle with respect to the heatable drum is provided between the input-side and output-side deflection pulley.

DE 697 08 401 T2 furthermore discloses a method for stamping a pattern on a film, and a device therefor. A thermoplastics film passes through a heating device before being deflected to a stamping pattern roller. A stamping pattern processing device comprising a conveyor belt that is driven by a first and second roller is assigned to the stamping pattern roller. A conveyor belt stretch between the first and second roller is positioned so as to be adjacent to the stamping pattern roller. This results in a fixed wrap angle of the conveyor belt relative to the stamping pattern roller. A draw-off roller is positioned downstream of said stamping pattern processing device and positioned so as to be fixed relative to the stamping pattern roller, as a result of which a fixed wrap angle relative to the stamping pattern roller exists between the thermoplastics film feed and the discharge.

U.S. Pat. No. 2,442,443 A discloses a device for pressing plastics materials. In this case, an application device is provided which comprises a hollow drum that is rotatably driven by a belt. Between said belt for driving the application device, and a further conveyor belt, the plastics material to be pressed is guided around the rotatable drum. The plastics material first passes through a heating zone, and then a cooling zone. The wrap angle of the plastics material to be pressed is specified by a fixed arrangement of the deflection pulleys for the conveyor belt.

EP 1 916 330 A1 discloses a method for producing a carpet according to a tufting method, in which a web material is fed to an application device by means of a guide pulley and subsequently discharged from the application device by means of a downstream guide pulley. The web material that is fed in comprises a tufting substrate in which pile yarns are sewn. The back of the tufting substrate, comprising loops of the pile yarns that are pushed through the tufting substrate, is brought into contact with the application device which is formed as a heatable drum of a calander. A feed-side and discharge-side guide pulley specifies the contact of the web material, relative to the wrap angle, on the heated drum. At an operating point in which the second calander roll is opposite the heated drum, the web material is pushed against the tufting substrate, under pressure, and pressed flat.

DE 10 2014 108 121 A1 furthermore discloses a method and a device for producing a primary backing on a web material. According to this method, the web material is guided along a fixed application head. The web material is first guided along a heated deflection region of the application head, before the web material being guided through a gap formed between a counterpressure roller and the application head, wherein the gap is smaller than the height of the web material before the gap. After being guided out of the gap, the web material is cooled along a cooling device.

The object of the invention is that of proposing a method for producing a primary backing for a web material, in particular consisting of non-woven fabric or a felt or a tufted substrate material, which method is furthermore simplified and allows for higher productivity.

This object is achieved by a method in which the wrap angle of the web material relative to the application device is set depending on a transport speed of the web material and/or a processing temperature of the web material. As a result, specific adaptation to the material to be processed is made possible in a simple manner. If the web material to be processed softens quickly, for example, the web material can be guided along the application device at an increased web speed. In this case, a smaller wrap angle is set. However, if the web material to be processed has a high softening temperature, it is advantageous to set a larger wrap angle of the web material relative to the application device, such that a longer heating duration is made possible. At the same time or alternatively, it is also possible for the transport speed to be reduced. For example, in the case of a larger wrap angle, quicker melting of the rear face of the web material, in particular the piling ends of the piling nap or the pulled-through loops of the pile yarns, can be achieved. At the same time, the larger wrap angle can also cause an increase in the transport speed, as a result of which the productivity is increased.

The conveyor belt of the web guide means is preferably held in a tensioned manner by means of at least one first and one second roller, and is driven in a revolving manner while the web material is being guided along the application device. As a result, the conveyor belt forms not only a working gap that extends along the wrap angle, but, by way of the conveyor belt, assists the guidance of the web material along the application head, such that possible warpage during melting or hearing of the web material is prevented.

In order to set the wrap angle, the web guide means and the application device are preferably moved relative to one another, and so as to be mutually spaced. The web guide means is preferably provided on a carriage. In particular, the web guide means can be moved towards the application device or distanced therefrom, by means of said carriage, in order to set the wrap angle of the conveyor belt between a first and second roller, relative to the application device.

It is preferable for a belt tension of the conveyor belt of the web guide means to be set by a tension roller that is assigned to the first and the second roller. As a result, the spacing between the first and the second roller can be kept constant, such that, when the web guide means feeds onto the application device, the wrap angle can be set in a defined manner, depending on the immersion depth of the application device between the at least one first and second roller. The tension roller can thereupon separately apply a web tension to the conveyor belt, as a result of which a contact force of a portion of the conveyor belt, in the region of the wrap angle relative to the application device, is set.

It is alternatively possible for the first and/or the second roller to be able to be actuated by an additional adjustment movement, in order to tension the conveyor belt, instead of using an additional tension roller.

The first roller is positioned on the input side and the second roller is positioned on the output side, relative to the application device, and the wrap angle is preferably set in a manner dependent on the immersion depth of the application device between the first and the second inlet roller. Depending on the material selection for the web material and/or the piling yarns, a longer or shorter melting time may be required, and therefore the wrap angle can also be adjusted thereupon. In the case of materials in which the yarn has a higher glass transition temperature and/or a larger diameter until melting, a larger wrap angle is set.

The tension roller is preferably mounted between the first and second tension roller, wherein the belt tension of the conveyor belt is set by means of a displacement movement remote from the first and second roller. The wrap angle of the conveyor belt relative to the application head is preferably determined first, and subsequently the tension roller is actuated in order to assume the required belt tension depending on the assumed wrap angle.

The web guide means is preferably displaced relative to the application device, in order to set the wrap angle, and the contact force of the web material, via the conveyor belt, on the application device is set by an adjustment movement of the first and/or second roller and/or of the tension roller of the web guide means. As a result, flexible adaptation to the web material to be processed is made possible.

The rear face of the web material is melted or fused, and smoothed, by means of at least one heatable sealing head of the application device. The sealing head advantageously comprises heated metal sheets, along which the rear face is guided, and the smoothing is applied. Furthermore, the primer introduced by the sealing head is immediately cooled by means of a downstream cooling head of the application device, such that warpage-free further transport and removal is made possible once the smoothed web material has been guided out.

It is furthermore possible for the first roller of the web guide means, which is provided on the inlet side relative to the application device, to be driven as a braking roller, and for the second roller, which is provided on the outlet side relative to the application device, to be driven as a friction drive roller, and for the friction drive roller to preferably be driven at the same rotational speed as, or at a higher rotational speed than, the braking roller. This makes it possible for the web material to always be held under tension while being guided through the working gap between the application device and the conveyor belt, such that defined working conditions result.

The object of the invention is furthermore achieved by a device for producing a primary backing on a web material, in which the wrap angle of the web material relative to the application device can be set by means of a displacement movement of the web guide means and the application device relative to one another. As a result, the web material can be guided along the application device at a specified and settable wrap angle, such that the web material contacts the application device in a controlled manner, and thus targeted melting of the web material of an outer layer or ply of the web material is achieved.

The web guide means preferably comprises at least one first and second roller which guides and drives the conveyor belt in a revolving manner. As a result, the transport of the web material is supported during the guidance along the application device. This makes it possible for the web tension of the web material to be guided through the device to be reduced, with the result that minimization of warpage of the web material during melting or fusing of the loops or piling ends on the application device is prevented.

The respective ends of the at least one first and second roller of the web guide means are advantageously received together on a carriage. The application device and/or the carriage may be displaceable along the base frame. In particular, the carriage can be arranged so as to be displaceable in height, relative to the application device. As a result, the wrap angle of the conveyor belt relative to the application device can be set in a simple manner, since the application device is arranged in a region between the first and second roller of the web guide means The degree of wrap of the application device can be set depending on the displacement direction, in particular in the Z-axis.

The first and second roller are advantageously arranged so as to be at a fixed spacing, in particular on a carriage, and a tension roller is provided so as to be assigned thereto, by means of which tension roller the belt tension of the conveyor belt can be set. The belt tension can be set by means of a displacement movement of the tension roller, in particular in the Z-direction. It is alternatively possible for the first and/or the second roller of the web guide means to be arranged so as to be displaceable, such that a belt tension of the conveyor belt can also be set by means of a relative movement of the first roller with respect to the second roller.

According to a further preferred embodiment of the device, the first and second roller, as well as the tension roller, are positioned in a triangular arrangement relative to one another, and a portion of the conveyor belt extending between the first and second roller is assigned for forming the wrap angle relative to the application device. This allows for a structurally simple design.

It is advantageous for the first and the second roller of the web guide means to be driven, wherein the first guide roller is formed, on the input side, as a braking roller, and the second guide roller is designed as a friction drive roller, on the output side relative to the application head. As a result, the web tension of the web material can be set while the web material is being guided through the working gap formed between the conveyor belt of the web guide means and the application device.

The application device preferably comprises a sealing head that is heatable. The melting and fusing of the rear face of the web material can be actuated as a result. The sealing head is preferably formed as a heated metal sheet or a heatable metal sheet assembly comprising at least one chamber for a temperature-control medium. This may be temperature-controlled in particular by means of oil. Alternatively, electrical temperature control may be provided. In this case, the metal sheet is heated to a temperature such that the material to be melted is heated to the glass transition temperature thereof or to a temperature thereabove.

It may advantageously be possible for the application device to comprise a cooling head that adjoins the sealing head. As a result, quick hardening of the fused layer or ply can be achieved after a layer or ply has been melted onto the web material, in particular piling nap of a carpet to be manufactured. This prevents warpage of the web material. Homogenous smoothing can also be achieved. Furthermore, the adjacent conveyor belt guides the web material along the application device in a controlled manner, and both melting and cooling of the web material take place in the working gap formed by the conveyor belt.

The cooling head is preferably formed as a metal sheet through which a coolant flows, or as a sheet assembly comprising at least one chamber for a temperature-control medium. A separate cooling circuit may be provided for this purpose.

The sealing head and the cooling head may be an application device that is designed as a roller. The segment region of the sealing head, at the outer periphery thereof, is preferably equal to or larger than the segment region of the cooling head. It may be possible for the effective region of the sealing head and of the cooling head to be set, within the wrap angle, by means of rotating the roller about the longitudinal axis thereof.

It is preferably possible for a tear-off edge to be formed between the sealing head and the cooling head. As a result, an improved surface quality of the smoothed primer can be achieved.

It is preferably possible for the conveyor belt of the belt guide means to be formed as a chain-like belt, as a fabric-like belt or as spiked belt. The corresponding conveyor belt material is selected depending on the web material to be processed, and on the weight per unit area, and/or on the required processing speeds or web tensions.

The invention, and further advantageous embodiments and developments thereof, will be described and explained in greater detail in the following, with reference to the examples shown in the drawings. The features in the description and the drawings can be applied according to the invention either individually or in any desired combination. In the drawings:

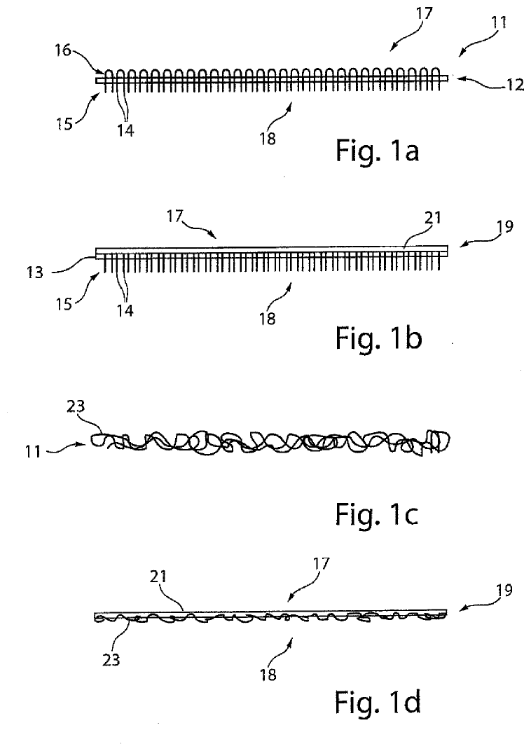

FIG. 1a is a schematic side view of a substrate material tufted with a piling yarn,

FIG. 1b is a schematic side view of the web material, according to FIG. 1a, that is produced by the method according to the invention and the device according to the invention,

FIG. 1c is a schematic side view of a web material to be processed, consisting of a non-woven fabric,

FIG. 1d is a schematic view of a web material, according to FIG. 1c, that is processed by the method according to the invention and the device according to the invention,

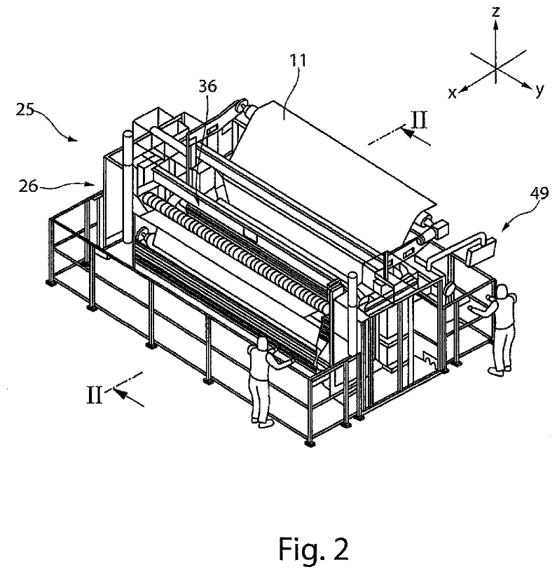

FIG. 2 is a perspective view of the device according to the invention,

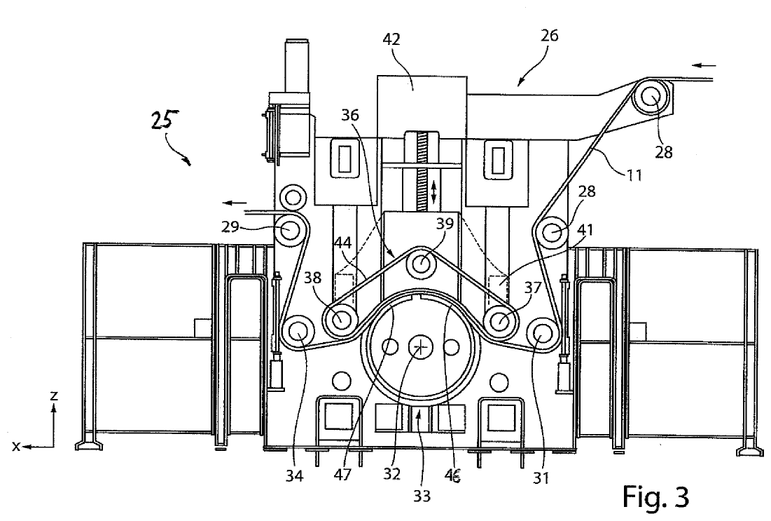

FIG. 3 is a schematic cross section of the device according to the invention according to FIG. 2, and

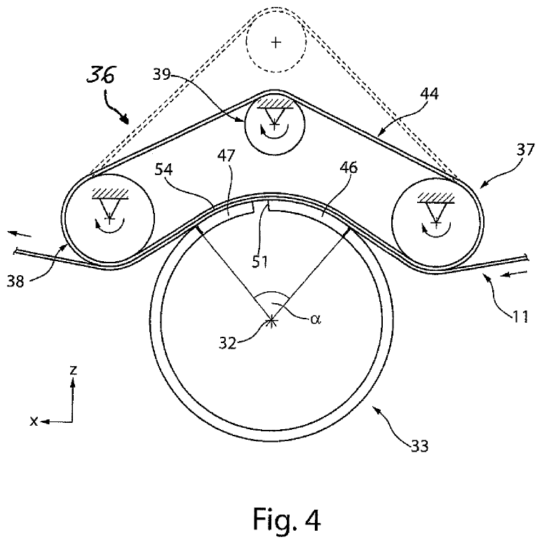

FIG. 4 is a schematically simplified view of an application device comprising a web guide means of the device according to FIG. 2 that is assigned thereto.

FIG. 1a is a schematic side view of the web material 11 to be processed, which material is for example a tufted substrate material 12 that consists of a woven fabric 13 or a non-woven fabric and in which at least one piling yarn 14 is introduced by tufting, in order to form piling nap 15 in the form of meshes or loops. Said piling nap comprises piling ends 16 which protrude from a rear face 17 of the tufted substrate material 12, relative to the woven fabric 13. Said piling ends 16 are preferably formed as loop-like end portions. The pining nap 15 is often cut towards the front face 18 of the tufted substrate material 12, such that some freely producing ends of the piling yarn 14 can form a surface 18 of a carpet. It may alternatively be possible for the piling nap 15 that is directed towards the front face to be formed by loops, i.e. to be closed.

The piling yarn 14 consists of polymers, in particular thermoplastic polymers, for example polyester, polypropylene, polyamide or the like. The woven fabric may consist of the same polymer family as the piling yarn 14.

In the case of a tufted substrate material 12 of this kind, the piling nap 15 is only preliminarily fixed to the woven fabric 13, and a permanent connection between the piling ends 16 and the woven fabric 13 is required in order to form a primary backing 19. FIG. 1b shows a primary backing 19 of this kind which is produced by the method described in greater detail in the following, and in particular the device for carrying out the method. The piling ends 16 have been at least softened, and subsequently smoothed, under the action of temperature, in order to form a preferably closed surface on the rear face 17 of the woven fabric 13, for fixing the piling yarns 14. This layer, on the rear face 17 of the woven fabric 13, that is formed by the material of the piling ends 16, is referred to as a primer 21. A primary backing 19 of this kind can subsequently be provided with a backing coating (not shown in greater detail), referred to as a secondary backing. For example, a foam, in particular consisting of latex, may be applied. Textile sheets, polyurethane foams, other sheets, or coatings are also possible as a secondary backing, depending on the application.

The tufted substrate material 12 described in FIG. 1a, comprising the piling yarn 14 arranged therein for forming piling nap 15 may be provided as a primary backing 19 for carpets. Furthermore, said tufted substrate material 12 can be used to form artificial grass or further floor coverings, or other coverings.

FIG. 1c shows a web material 11 consisting of a non-woven fabric, which is formed as a fabric consisting of a plurality of fibers 23. These may be fibers of a restricted length, continuous fibers or filaments, or cut yarns which are combined and interconnected, in any manner, to form a non-woven fabric, i.e. a fiber layer. Alternatively, the web material 11 may also be formed by a felt, i.e. a textile sheet consisting of disordered fiber material that can be separated only with difficulty.

FIG. 1d shows the web material 11 that is formed as a non-woven fabric layer by means of the method according to the invention, which is described in greater detail in the following, in particular a device for carrying out the method. The primary backing 19 consists of a primer 21 that forms a smooth and preferably completely closed rear face, wherein the untreated surface of the non-woven layer is provided on the front face 18. Similar also applies if a felt layer is used instead of a non-woven layer.

FIG. 2 is a perspective view of a device 25 for producing a primary backing 19 on a web material 11, for example according to FIGS. 1a to 1d. FIG. 3 is a schematic cross section along the line II-II in FIG. 2.

The device 25 comprises a base frame 26, wherein one or more feed rollers 28 and discharge rollers 29 are mounted, in each case, between a left-hand and right-hand portion of the base frame 26. The web material 11 is drawn off a storage roll (not shown in greater detail) and fed to a guide roller 31 via the feed rollers 28, and deflected, in order to feed the web material 11 to and guide said web material along an application device 33 that is preferably formed as a roller, in order to subsequently discharge the processed web material 11 via a guide roller 34 downstream of the application device 33, and to remove said web material from the device 11 via the discharge roller 29.

A web guide means 36, which cooperates with the application device 33 in order to produce a smooth primer on the rear face 17 of the web material 11, is assigned to the application device 33.

The web guide means 36 comprises a first and second roller 37, 38 and preferably a tension roller 39, by means of which a conveyor belt 44 is guided in a revolving manner. The first roller 37, second roller 38 and the tension roller 39 are advantageously positioned in a triangular arrangement relative to one another. Said first roller 37, the second roller 38 and preferably the tension roller 39 are mounted together, on a carriage 41, at the relevant end region, as a result of which the web guide means 36 are movable, together, up and down along the Z-axis, by means of a drive 42. In addition, the tension roller 39 is displaceable relative to the first and second roller 37, 38, along the Z-axis, in order to tension the conveyor belt 44. The conveyor belt 44 is guided in a revolving manner by means of the first roller 37, the second roller 38 and the tension roller 39. The first roller 37 and the second roller 38 are preferably driven. The tension roller 39 is merely rotatably mounted. The conveyor belt 44 can be driven in the transport direction of the web material 11, by means of the first roller 37 and second roller 38.

The application device 33 comprises a sealing head 46, and a cooling head 47 downstream of said sealing head 46. The application device 33 may likewise be mounted so as to be rotatable about the longitudinal axis 32 thereof, such that different regions of the application device 33 can be set in a manner facing the web guide means 36. The application device 33 is for example formed as a roller.

The device 25 can be actuated and set, with respect to individual method parameters, by means of a controller 49 and a data processing means.

The web guide means 36 that is assigned to the application device 33 is shown in a schematically simplified manner in FIG. 4. The mode of operation of the web guide means 36 of the application device 33, in order to achieve a primer 21 on the web material 11, will be discussed in greater detail with reference to FIG. 4.

The application device 33 comprises the sealing head 46 that is formed by a heatable metal sheet. Said sealing head 46 comprises a curved guide surface, for example consisting of sheet metal, along which the piling ends 16 of the web material 11 are guided. The sealing head 46 may comprise channels for guiding heated oil. Said oil may be heated to 285° C. for example, in order to also allow for rapid melting of the piling ends 16 or of the fibers of the web material 11. Alternatively, it is also possible for different electrical heating elements to be provided on or in the sealing head 46. The cooling head 47 preferably likewise comprises a metal sheet having a smooth outer face. The cooling temperature may be below 60° C. for example. The curvatures of the metal sheet of the sealing head 46 and of the cooling head 47 are preferably located on a common outer diameter. A tear-off edge 51 is formed between the sealing head 46 and the cooling head 47, such that the melted or fused material on the rear face 17 of the web material 11 separates from the sealing head 46 in a defined manner.

The first and second roller 37, 38 of the web guide means 36 are mutually spaced, such that a portion of the conveyor belt 44 extending therebetween can be positioned at a wrap angle α relative to the application device 33. The size of the wrap angle α of the conveyor belt 44 with respect to the application device 33 is dependent on the spacing of the axes of rotation of the first and second roller 37, 38 from the rotational axis 32 of the application device 33. The immersion depth of the application device 33 between the first and second roller 37, 38 this determines the wrap angle α. In the case of a spacing between the first and second roller 37, 38 that is greater than the diameter of the application device 33, a wrap angle α of up to 180° can be achieved. Said wrap angle α is preferably smaller.

A working gap 54, in which the web-like material 11 is guided along the application device 33, is formed between the conveyor belt 44 that extends between the first roller 37 and the second roller 38. The length of the working gap 54 is determined by the wrap angle α of the conveyor belt 44 with respect to the application device 33. The application device 33 is stationary.

The size or thickness of the working gap 54 can also be achieved by a displacement movement of the tension roll 39 in the Z-direction. This increases the tension of the conveyor belt 44, as a result of which the working gap 54 becomes smaller. In the case of a low tension of the conveyor belt 44, the web material 11 is guided through the working gap 54 only slightly compressed.

In the embodiment according to FIG. 4, the conveyor belt 44 is formed as a spiked belt for example. As a result, the web material 11 can be guided through the working gap 54 in a warpage-free manner. Warpage of the web material 11, which may be promoted by the heating, is prevented as a result. Alternatively, further materials may also be used to form the conveyor belt 44, such as a woven fabric belt or a rubberized woven fabric belt.

The second roller 38, which is preferably formed as a friction drive roller, is driven at the same drive speed as or at a higher drive speed than the first roller 37 or braking roller. As a result, the web material 11 can be guided through the working gap 54, formed in a region of the wrap angle α, under traction.

Further segments for heating and cooling may be provided within the application device 33, which segments can be used according to the positioning of the application device 33 relative to the wrap angle α.

The arrangement and orientation of the web guide means 36 shown in FIG. 4 can also be arranged so as to be offset by 180° relative to the application device 33. This likewise allows for the mode of operation described above.

In the case of a constant spacing of the first and second roller 37, 38, the wrap angle α can be set by the immersion depth of the application device 33 between the first and second roller 37, 38. The spacing between the web guide means 36 or the carriage 41, and the application device 33, is reduced or increased. If the first and second roller 37, 38 are also mounted on the base frame 26 so as to be movable towards one another, the wrap angle α can additionally also be set by the spacing of the two rollers 37, 38.

According to an embodiment that is not shown in greater detail, the web guide means 36 can additionally also comprise a counterpressure roller which is provided for example opposite the sealing head 46, in particular opposite the tear-off edge 51 on the sealing head 46. As a result, said counterpressure roller can also be positioned within the conveyor belt 44, as can the further rollers 37, 38 and the tension roller 39.

The size of the wrap angle α is preferably dependent on the speed of the conveyor belt, in order to guide the web material through the working gap. The softening temperature of a layer or a ply of the web material to be processed is a further parameter for determining the wrap angle α and/or the transport speed. The method described above and the device allow for individual adaptation to the web material to be processed, and high productivity.

We claim:

1. Method for producing a primary backing on a web material, the method comprising:
the web material is fed to an application device by means of a first guide roller and subsequently discharged from the application device by means of a downstream second guide roller, and,
the web material is guided along the application device by a web guide means, and, the web material is guided adjacently to the application device by a conveyor belt of the web guide means, and,
the conveyor belt of the web guide means is held in a tensioned manner by at least one first roller and one second roller, and, is driven in a revolving manner while the web material is being guided along the application device, and,
the first roller is positioned on an input side and the second roller is positioned on an output side of the application device, and, the conveyor belt is held at a wrap angle (α) relative to the application device, and the web material is guided along the application device so as to be adjacent thereto, within the wrap angle (α), and,
the wrap angle (α) is set in a manner depending on a transport speed or a processing temperature of the web material.

2. Method according to claim 1, wherein the wrap angle (α) is set in a manner depending on an immersion depth of the application device between the first roller and the second roller, and, a carriage that receives the web guide means and the application device are moved relative to one another to set the wrap angle (α).

3. (canceled)

4. Method according to claim 1, wherein a belt tension of the conveyor belt of the web guide means is set by a tension roller that is assigned to the first and the second roller, or, the belt tension of the conveyor belt of the web guide means is set by the first roller and the second roller, by means of an adjustment movement of the first roller and the second roller relative to one another.

5. Method according to claim 4, wherein the tension roller is mounted between the first roller and the second roller, and the belt tension of the conveyor belt is set by means of a displacement movement of the tension roller remote from the first roller and the second roller.

6. Method according to claim 1, wherein the web guide means is displaced relative to the application device, in order to set the wrap angle (α), and, a contact force of the web material, via the conveyor belt, on the application device is set by an adjustment movement of the first roller, or, the second roller, or, the tension roller.

7. Method according to claim 1, wherein the application device further comprises at least one heated sealing head, by means of which a face of the web material that faces the sealing head is melted or fused, and smoothed to form a primer on the web material.

8. Method according to claim 7, the application device further comprises a cooling head downstream of the heated sealing head, and the cooling head cools the primer on the web material.

9. Method according to claim 8, wherein the conveyor belt of the web guide means is positioned relative to the application device such that a set wrap angle of a portion of the conveyor belt between the first and second roller, relative to the application device, causes the web material to be guided along the sealing head and the cooling head.

10. Method according to claim 1, wherein the first guide roller, is operated as a braking roller, and the second guide roller, is driven as a friction drive roller, and, the friction drive roller is driven at the same rotational speed as, or, at a higher rotational speed, than, the braking roller.

11. A Device for producing a primary backing on a web material, comprising:
i) a base frame, and,
ii) an application device that is carried by the base frame, and,
iii) a first guide roller on an input side of the application device, and
iv) a second guide roller on an output side of the application device, and,
v) a web guide means comprising: a first roller and a second roller, which drive a conveyor belt in a revolving manner and thereby guide a web material along the application device so as to be adjacent, and at a wrap angle relative thereto, and,
vi) wherein the wrap angle is set in a manner dependent on at least one of a transport speed and a processing temperature of the web material.

12. Device according to claim 11, wherein the first roller and the second roller are attached to a carriage, and the carriage and the application device are arranged on the base frame so as to be displaceable, and, the carriage is arranged so as to be displaceable in height, relative to the application device.

13. Device according to claim 11, wherein a belt tension of the conveyor belt is set by at least one of:
a) the first roller and the second roller are arranged so as to be at a fixed spacing relative to one another, and, a tension roller is provided so as to set the belt tension of the conveyor belt, and,
b) the first roller and the second roller are displaced relative to one another to set the belt tension of the conveyor belt.

14. Device according to claim 13, wherein the first roller and the second roller and the tension roller, are positioned on the carriage in a triangular arrangement relative to one another, and, positioned so as to determine the wrap angle.

15. Device according to claim 11 wherein, at least one of the first guide roller and the second guide roller are driven, and the first guide roller is a braking roller, and the second guide roller is a friction roller.

16. Device according to claim 11, wherein the application device further comprises at least one sealing head.

17. Device according to claim 16, wherein the sealing head is formed as a heated metal sheet or a metal sheet assembly comprising a chamber, having a curved surface, which metal sheet is temperature-controlled, by means of oil or electrically.

18. Device according to any of claim 16, wherein the application device further comprises a cooling head through which a coolant preferably flows.

19. Device according to claim 18, wherein the sealing head and the cooling head are provided in the application device that is formed as a roller having a rotational axis, and the heating surface of the sealing head and a cooling surface of the cooling head extend over a common outer periphery, and,
the application device, is controlled by means of a rotation about the rotational axis, with respect to the positioning of the sealing head and of the cooling head, within the wrap angle and relative to the conveyor belt.

20. (canceled)

21. Device according to claim 18, wherein a tear-off edge is formed between the sealing head and the cooling head, at an end of the sealing head.

22. Device according to claim 11, wherein the conveyor belt is formed as a chain-like belt, or a fabric-like belt, or a spiked belt.
